(19) United States
(12) Patent Application Publication
(10) Pub. No.: US 2010/0052558 A1
(43) Pub. Date: Mar. 4, 2010

(54) BACKLIGHT ASSEMBLY, DRIVING METHOD THEREOF AND DISPLAY APPARATUS

(75) Inventors: Sang-hoon LEE, Suwon-si (KR); Joon-hyun YANG, Suwon-si (KR); Tae-hoon KIM, Suwon-si (KR); Youn-hee KIM, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/549,807

(22) Filed: Aug. 28, 2009

(30) Foreign Application Priority Data
Aug. 29, 2008 (KR) 10-2008-0085353
Nov. 17, 2008 (KR) 10-2008-0113835

(51) Int. Cl. H05B 41/24

(52) U.S. Cl. 315/250

(57) ABSTRACT

Disclosed are a backlight assembly, a driving method thereof and a display apparatus. The backlight assembly includes: a light source unit which has a plurality of point light source strings; a plurality of driving elements which are connected to the plurality of point light source strings; a detector which detects currents flowing in the plurality of point light source strings; and a light source driver which generates driving pulses to drive the plurality of driving elements in a linear operating region, adjusts duty ratios of the driving pulses based on at least one of the detected currents so that the currents flowing in the plurality of point light source strings are within a range.

### CROSS-REFERENCE TO RELATED APPLICATIONS

This application claims priorities from Korean Patent Application Nos. 10-2008-0085353, filed on Aug. 29, 2008, and 10-2008-0113835, filed on Nov. 17, 2008 in the Korean Intellectual Property Office, the disclosures of which are incorporated herein in their entirety by reference.

### BACKGROUND OF THE INVENTION

1. Field of the Invention

Apparatuses and methods consistent with the present invention relate to a backlight assembly, a driving method thereof and a display apparatus, and more particularly, to a backlight assembly which has a light source to adjust a brightness through a current control, a driving method thereof and a display apparatus.

2. Description of the Related Art

In recent years, flat display devices such as a liquid crystal display (LCD), a plasma display panel (PDP) and an organic light emitting diode (OLED) have increasingly replaced cathode ray tubes (CRT).

As a liquid crystal panel of the LCD does not emit light by itself, a backlight unit for emitting light is arranged in a rear side of the liquid crystal panel. Transmittance of light which is emitted by the backlight unit is adjusted by arrangement of liquid crystals. The liquid crystal panel and the backlight unit are accommodated in an accommodating member such as a chassis. A light source which is used in the backlight unit may include a linear light source such as a lamp and a point light source such as a light emitting diode (LED). Among them, the LED has drawn a lot of attention lately.

In case of the LED used as the point light source, brightness of the LED is controlled through a current control controlling a current level of power consistently. The backlight assembly typically includes a current source device as a switch controlling power supplied to the point light source, and among the types of the current source devices, a switch type current source device includes an inductor such as a coil.

Meanwhile, there is a current source device which uses a switching element in an active area without employing a large-size component such as an inductor. Also, a backlight assembly which adjusts brightness of a point light source only with turn-on time of the switching element has been developed.

### SUMMARY OF THE INVENTION

Accordingly, it is an aspect of the present invention to provide a backlight assembly which solves the problem of heat generation by reducing conduction loss, a driving method thereof and a display apparatus.

Also, it is another aspect of the present invention to provide a backlight assembly which uniformly maintains brightness of a point light source string, a driving method thereof and a display apparatus.

Additional aspects of the present invention will be set forth in part in the description which follows and, in part, will be obvious from the description, or may be learned by practice of the present invention.

The foregoing and/or other aspects of the present invention are also achieved by providing a backlight assembly including: a light source unit which has a plurality of point light source strings; a plurality of driving elements which are connected to the plurality of point light source strings; a detector which detects currents flowing in the plurality of point light source strings; and a light source driver which generates driving pulses to drive the plurality of driving elements in a linear operating region, adjusts duty ratios of the driving pulses based on at least one of the detected currents so that the currents flowing in the plurality of point light source strings are within a range.

The light source driver may adjust the duty ratios of the driving pulses so the plurality of point light source strings provide lights of uniform brightness.

The range may be determined according to a preset current range or a current range that is detected from a predetermined reference point light source string of the plurality of point light source strings.

The light source driver may include a lookup table that stores the duty ratios corresponding to the detected currents.

The light source driver may sequentially test-drive the plurality of driving elements and adjusts the duty ratios of the driving pulses when a system-on signal is received or when settings of brightness of light emitted from the plurality of point light source strings are changed.

The plurality of driving elements may include switch elements, and the switch elements act as switches in the linear operating region.

The light source driver may include a power source unit which is connected to the light source unit and supplies predetermined constant power to the light source unit; a driving pulse generator which generates the driving pulses; and a controller which adjusts numbers of the driving pulses output to the plurality of driving elements in a unit time according to corresponding dimming signals for the plurality of point light source strings.

The driving pulse generator generates 2ⁿ−1 number of driving pulses in the unit time if the dimming signals, each having a predetermined binary code, are input in the form of an n-bit code, the “n” being a natural number equal or greater than one (1), the controller outputs the number of the driving pulses to the driving elements such that each of the driving elements receives a number of driving pulses corresponding to a decimal value of the binary code of a dimming signal for a corresponding point light source string of the plurality of point light source strings in the unit time.

The light source driver may further include a storage unit which includes a first register and a second register each comprising a number of bits corresponding to a number of the plurality of point light source strings, and the controller extracts a first predetermined code from the predetermined binary codes of the dimming signals for the plurality of point light source strings with regard to m-th bits of n-bit codes of the dimming signals, the “m” being a natural number equal or greater than one (1), stores the first predetermined code in the first register, and outputs the number of the driving pulses corresponding to 2^{m-1} and binary values of the m-th bits of the n-bit codes to the plurality of driving elements.

The controller may store a second predetermined code with regard to a bit next to the m-th bit in the second register during which the driving pulses are output according to the first predetermined code stored in the first register.

The controller may output a latch signal to store in the first register the second predetermined code previously stored in the second register if the second predetermined code stored in the second register is different from the first predetermined code stored in the first register.

The light source driver may further include a plurality of AND operators. One of the plurality of AND operators receives a respective binary value of the first predetermined code stored in the first register, and the driving pulses output from the driving pulse generator for a respective AND operation, and output terminals of the plurality of AND operators are connected to the plurality of driving elements.

The controller may store the second predetermined code in series in the second register, and stores in the first register in parallel the first predetermined code previously stored in the second register.

Another aspect of the present invention is to provide a driving method of a backlight assembly which has a light source unit including a plurality of point light source strings, and a plurality of driving elements connected to the plurality of point light source strings, the driving method including: driving the plurality of driving elements; detecting currents flowing in the plurality of point light source strings; generating driving pulses to drive the plurality of driving elements in a linear operating region; adjusting duty ratios of the driving pulses based on the detected currents so the currents flowing in the plurality of point light source strings are within a range; and outputting to the plurality of driving elements the driving pulses of which duty ratios are adjusted, according to dimming signals to control brightness of the plurality of point light source strings.

Still another aspect of the present invention is to provide a display apparatus including: a display panel which displays an image thereon; a panel driver which applies an image signal to the display panel; a light source unit which comprises a plurality of point light source strings; a plurality of driving elements which are connected to the plurality of point light source strings; a detector which detects currents flowing in the plurality of point light source strings; and a light source driver which generates driving pulses to drive the plurality of driving elements in a linear operating region, drives the plurality of driving elements to detect currents flowing in the plurality of point light source strings, adjusts duty ratios of the driving pulses based on the detected currents so that the currents flowing in the plurality of point light source strings are within a range, and outputs to the plurality of driving elements the driving pulses of which duty ratios are adjusted, according to dimming signals based on the image signal.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is a control block diagram of a backlight assembly according to an exemplary embodiment of the present invention;

FIG. 2 is a graph which illustrates an output current with respect to a drain-source voltage to describe a driving area of a driving element in FIG. 1, according to an exemplary embodiment of the present invention;

FIG. 3 is a control flowchart to describe a driving method of the backlight assembly in FIG. 1, according to an exemplary embodiment of the present invention;

FIG. 4 is a control block diagram of a backlight assembly according to another exemplary embodiment of the present invention;

FIG. 5A illustrates a dimming signal with respect to a plurality of point light source strings in FIG. 4, according to an exemplary embodiment of the present invention;

FIG. 5B illustrates an extraction of a dimming signal to output a driving pulse in FIG. 5A, according to an exemplary embodiment of the present invention;

FIG. 6 illustrates signal waveforms with respect to a driving pulse applied to the driving element in FIG. 4, according to an exemplary embodiment of the present invention; and

FIG. 7 is a control block diagram of a display apparatus according to another exemplary embodiment of the present invention.

### DETAILED DESCRIPTION OF EXEMPLARY EMBODIMENTS

Hereinafter, exemplary embodiments of the present invention will be described with reference to accompanying drawings, wherein like numerals refer to like elements and repetitive descriptions will be avoided as necessary.

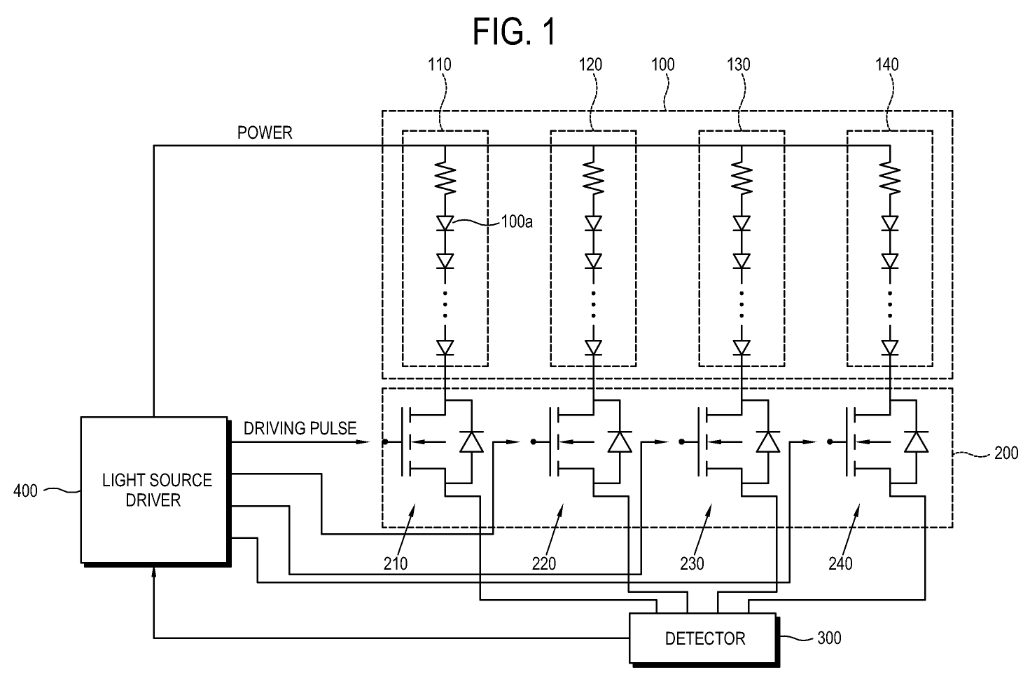

FIG. 1 is a control block diagram of a backlight assembly according to an exemplary embodiment of the present invention.

As shown therein, a backlight assembly includes a light source unit 100 which has a plurality of point light source strings 110, 120, 130 and 140; a plurality of driving elements 210, 220, 230 and 240 which are individually connected to the respective point light source strings 110, 120, 130 and 140; a detector 300 which detects currents flowing in the point light source strings 110, 120, 130 and 140; and a light source driver 400 which drives the driving elements 210, 220, 230 and 240.

Each of the point light source strings 110, 120, 130 and 140 includes at least one point light source 100a, and emits light with different brightness depending on supplied power. The point light source 100a according to the present exemplary embodiment includes a light emitting diode (LED) and is formed in an LED circuit substrate (not shown). The point light source 100a may include an LED group (not shown) which emits different light such as red, green and blue light. The LED group includes three or four LEDs. The LED group may further include a white LED. The point light sources 100a which emit light in the same color may be connected in series to form a point light source string.

First ends of the point light source strings 110, 120, 130 and 140 are connected to the light source driver 400 while the other ends thereof are connected to the driving elements 210, 220, 230 and 240, respectively. Each of the point light source strings 110, 120, 130 and 140 is independently driven by a corresponding one of the driving elements 210, 220, 230 and 240. Brightness of light, a duration of light emission and a emitting time of each of the point light source strings 110, 120, 130 and 140 may be adjusted differently by driving the driving elements 210, 220, 230 and 240, individually. A partial control of brightness of light emitted by the backlight assembly is called a local dimming, which may be easily realized if the point light source 100a is employed as the light source.

However, if the LED is used as the point light source, a forward voltage of the LED may be changed by an external temperature, deterioration of the LED, etc. As a result, the currents which flow in the point light source strings 110, 120, 130 and 140 may be changed, and the brightness of light emitted by each of the point light source strings 110, 120, 130 and 140 may be changed unintentionally.

The driving elements 210, 220, 230 and 240 are connected to the first ends of the point light source strings 110, 120, 130 and 140, and control driving power. If the driving elements 210, 220, 230 and 240 are turned on, a closed circuit is formed to allow the current input by the power source unit in the light source driver 400 to flow in the point light source strings 110, 120, 130 and 140. If the driving elements 210, 220, 230 and 240 are turned off, the current is not supplied to the point light source strings 110, 120, 130 and 140 as the closed circuit is not formed. Whether the driving elements 210, 220, 230 and 240 are turned on is determined by a driving pulse output by the light source driver 400. The driving elements 210, 220, 230 and 240 may include metal oxide semiconductor field-effect transistors.

The detector 300 detects currents flowing in the point light source strings 110, 120, 130 and 140, and supplies the currents to the light source driver 400. The detector 300 may include a resistor or a hall sensor that is not shown. If the currents are detected by a resistor, the detector 300 may include a current amplifier to amplify the currents and a noise filter to remove noise include therein. The detector 300 may further include an analog/digital converter to convert the detected currents into digital signals to be used by the light source driver 400. The detector 300 may include a resistor or a hall sensor connected to each of the point light source strings 110, 120, 130 and 140, or include a resistor or a hall sensor simultaneously connected to at least two point light source strings 110, 120, 130 and 140. If the driving elements 210, 220, 230 and 240 are turned on and power is supplied to the point light source strings 110, 120, 130 and 140, the detector 300 detects a current flowing in each of the point light source strings 110, 120, 130 and 140.

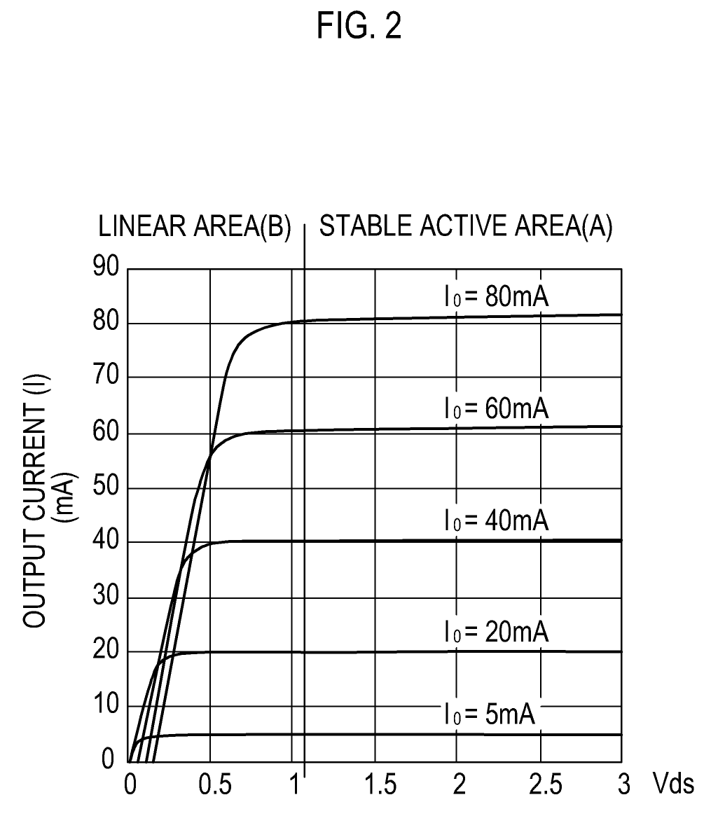

The light source driver 400 generates driving pulses to drive the driving elements 210, 220, 230 and 240 in a linear area (or a linear operating region), and outputs the driving pulses to the driving elements 210, 220, 230 and 240 according to predetermined dimming signals. Driving power is supplied to the point light source strings 110, 120, 130 and 140 by the driving pulses output to the driving elements 210, 220, 230 and 240. FIG. 2 illustrates a graph to describe a driving area of the driving elements 210, 220, 230 and 240 depending on a driving pulse. An axis x in the graph refers to a drain-source voltage Vds of the driving elements 210, 220, 230 and 240 while an axis y refers to an output current I flowing in the drain-source of the driving elements 210, 220, 230 and 240. The light source driver 400 according to the present exemplary embodiment controls brightness of the point light source strings 110, 120, 130 and 140 through a control of the driving elements 210, 220, 230 and 240 without employing components such as an inductor. As in FIG. 2, if the drain-source voltage Vds applied to the driving elements 210, 220, 230 and 240 exceeds a certain level, currents flowing in the driving elements 210, 220, 230 and 240, i.e., the output currents Is supplied to the point light source strings 110, 120, 130 and 140 are maintained consistently. An area which represents such characteristics is called a stable active area A. Meanwhile, the output currents Is drastically increase with respect to the drain-source voltage Vds within the linear area B before reaching the stable active area A. The light source driver 400 according to the present exemplary embodiment generates driving pulses to control the driving elements 210, 220, 230 and 240 in the linear area B, not in the stable active area A. A high level of the driving pulses applied to the driving elements 210, 220, 230 and 240 is higher than that of a gate voltage Vgs where a driving element is used as a current source. As an example, a high level may be at the same level as constant power applied to the light source unit 100. A low level of a driving pulse applied to the driving elements 210, 220, 230 and 240 may have a ground level. That is, the driving elements 210, 220, 230 and 240 which are controlled by the driving pulses act as switches. If the driving elements 210, 220, 230 and 240 are driven in the linear area B, the level of the drain-source voltage Vds is lower than that in the stable active area A. Thus, thermal energy is less consumed by the driving elements 210, 220, 230 and 240, and the light source driver 400 generates less heat. Also, a conduction loss which occurs in the stable active area A is reduced. The conduction loss occurs when the state of the driving elements 210, 220, 230 and 240 changes completely and they are turned on, and refers to an energy loss occurring due to a current and a voltage drop component in a current path. Meanwhile, if the plurality of driving elements 210, 220, 230 and 240 are provided as a single chip, effect of reducing heat generation further increases. In summary, according to the present exemplary embodiment, the driving elements 210, 220, 230 and 240 are controlled by the driving pulses in the linear area B and act as switching elements, instead of current sources, to thereby reduce energy consumption and heat generation.

The light source driver 400 individually drives the driving elements 210, 220, 230 and 240 so that currents flowing in each of the point light source strings 110, 120, 130 and 140, are detected, and adjusts duty ratios of driving pulses based on the detected currents. If the detector 300 includes a single resistor or a hall sensor, the light source driver 400 sequentially drives the driving elements 210, 220, 230 and 240 to detect the currents in a time division manner. If the resistor or the hall sensor is connected to each of the point light source strings 110, 120, 130 and 140, the light source driver 400 may simultaneously turn on the driving elements 210, 220, 230 and 240. According to the present exemplary embodiment, the light source driver 400 adjusts the duty ratios of the driving pulses to provide uniform brightness of the light source unit 100 by the light emitted by the plurality of point light source strings 110, 120, 130 and 140. As described above, the currents which flow in the point light source strings 110, 120, 130 and 140 determine brightness of the light, and the currents and brightness of the light are substantially in direct proportion to each other. Accordingly, the currents which flow in each of the point light source strings 110, 120, 130 and 140 are controlled to be in an allowable range to thereby control the brightness of the light emitted by the plurality of point light source strings 110, 120, 130 and 140. The allowable range may include a preset current range or be set as a current range flowing in a reference point light source string of the plurality of point light source strings 110, 120, 130 and 140. If it is determined that a detected current exceeds the allowable range and the brightness of light is high, the duty ratio is reduced. If it is determined that a detected current is below the allowable range and brightness of light is low, the duty ratio increases.

The light source driver 400 may perform a test drive to adjust a duty ratio of a driving pulse at a predetermined time, e.g., when a system-on signal is received or a setting related to brightness of the light emitted by the point light source strings 110, 120, 130 and 140 are changed. The test drive may be performed periodically or when a selection signal is received from a user to adjust the duty ratio. As the test drive of the driving elements 210, 220, 230 and 240 is performed before a full-scale drive, light which has more accurate and uniform brightness may be emitted. Also, it may be examined whether light corresponding to a change is emitted after the setting related to brightness is changed.

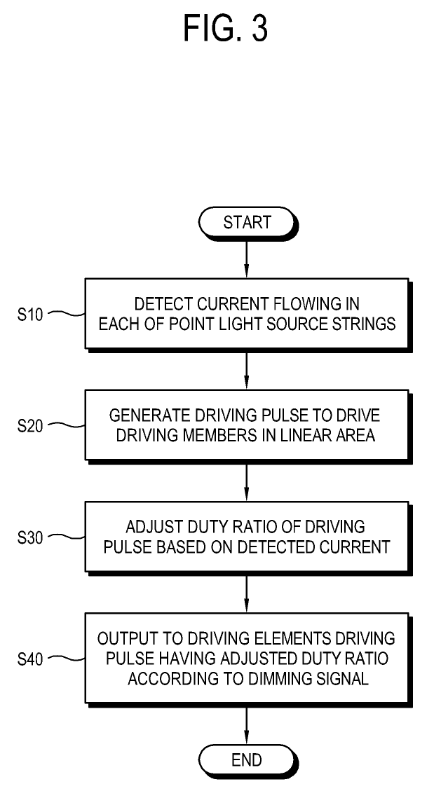

FIG. 3 is a control flowchart to describe a driving method of the backlight assembly. A driving method of the backlight assembly according to an exemplary embodiment of the present invention will be described with reference to FIG. 3.

First, the light source driver 400 drives each of the driving elements 210, 220, 230 and 240 so that a current flowing in each of the point light source strings 110, 120, 130 and 140 (S10) is detected. The driving pulses which are output to the driving elements 210, 220, 230 and 240 may have different frequencies from those of driving pulses applied when the driving elements 210, 220, 230 and 240 are driven normally, or may be generated additionally. The current is one of factors used to detect brightness of light emitted by the point light source strings 110, 120, 130 and 140. In another exemplary embodiment, another configuration, e.g., a light receiving sensor which detects emitted light and brightness may be provided to detect brightness.

The light source driver 400 generates a driving pulse to drive each of the driving elements 210, 220, 230 and 240 in the linear area (or linear operating region) (S20), and adjusts the duty ratio of each of the driving pulses generated based on the detected current (S30). The duty ratio of the driving pulse is individually adjusted for each of the driving elements 210, 220, 230 and 240 by reflecting characteristics and deterioration state of the point light source strings 110, 120, 130 and 140. Meanwhile, if the driving elements 210, 220, 230 and 240 are driven in the linear area, the conduction loss which occurs due to the driving elements 210, 220, 230 and 240 acting as the current sources is reduced as the driving elements 210, 220, 230 and 240 do not act as current sources but as switches to control the current.

Then, the light source driver 400 outputs to the driving elements 210, 220, 230 and 240 the driving pulses having the adjusted duty ratios according to the dimming signals used for adjusting the brightness of the point light source strings 110, 120, 130 and 140 (S40). The dimming signals are signals which determine turn-on or turn-off of the driving elements 210, 220, 230 and 240, and realize a local dimming through the light source unit 100. Each of the dimming signal has a predetermined binary code and is input in the form of an n-bit code (for example, “1111” or “0110” etc.), where “n” is a natural number equal to or greater than one (1).

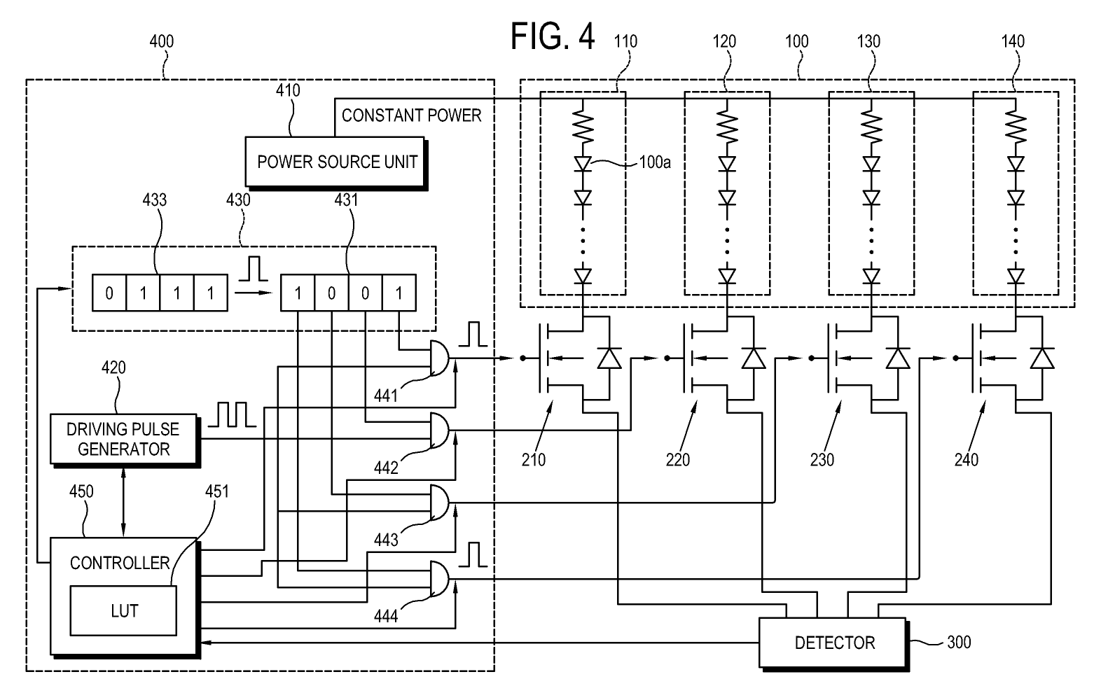

FIG. 4 is a control block diagram of a backlight assembly according to another exemplary embodiment of the present invention. The backlight assembly according to the present exemplary embodiment has a substantially equivalent configuration to the light source unit 100, the driving elements 210, 220, 230 and 240 and the detector 300 in FIG. 1. Thus, repetitive descriptions will be avoided.

As shown therein, a light source driver 400 includes a power source unit 410, a driving pulse generator 420, a storage unit 430, a plurality of AND operators 441, 442, 443 and 444 and a controller 450 which controls the foregoing elements.

The power source unit 410 includes a constant voltage source which is connected to a first end of a point light source 100a and supplies a voltage at a consistent level. The power source unit 410 may include a block to convert an AC power input from the outside into DC power, and a control block to maintain a voltage level of DC power consistently. Driving power which is output by the power source unit 410 is supplied directly to the point light source 100a. The cumulative amount of the current supplied to the point light source 100a by the constant power is adjusted by the number of the driving pulses applied to the driving elements 210, 220, 230 and 240 connected to a second end of the point light source 100a. The driving pulse is generated by the driving pulse generator 420, and a gray scale level which is represented by the light source unit 100 may be determined by the number of driving pulses applied finally to the driving elements 210, 220, 230 and 240 by a control of the controller 450.

The driving pulse generator 420 generates driving pulses to turn on the driving elements 210, 220, 230 and 240. If a dimming signal having a predetermined binary code is input in the form of an n-bit code, the driving pulse generator 420 generates 2ⁿ−1 number of driving pulses. For example, if a dimming signal is a four (4)-bit code, the number of driving pulses is 2⁴−1, that is 15. The generated driving pulses have reference duty ratios. The reference duty ratio may increase or decrease before the driving pulses are output to the respective driving elements 210, 220, 230 and 240 by the controller 450 (to be described later). For example, the reference duty ratio may be set as a maximum duty ratio.

The storage unit 430 includes a first register 431 and a second register 433 each of which has the number of bits corresponding to the number of point light source strings 110, 120, 130 and 140, respectively. As shown therein, the first register 431 and the second register 433 may store a four bit binary code corresponding to four point light source strings 110, 120, 130 and 140. Each of the binary codes of the first register 431 is input to a plurality of AND operators 441, 442, 443 and 444.

The AND operators 441, 442, 443 and 444 which include AND gates perform an AND operation to a driving pulse input by the driving pulse generator 420 and the binary code input by the first register 431, and selectively outputs the driving pulse according to the AND operation result. That is, if the binary code of the first register 431 is “1”, the driving pulses are output to the driving elements 210, 220, 230 and 240. If the binary code is “0”, the driving pulse is not output to the driving elements 210, 220, 230 and 240. To individually drive the plurality of driving elements 210, 220, 230 and 240, the number of the AND operators 441, 442, 443 and 444 corresponds to that of the point light source strings 110, 120, 130 and 140.

The controller 450 individually adjusts the duty ratio of the driving pulse generated by the driving pulse generator 420 for each of the driving elements 210, 220, 230 and 240 based on the current detected by the detector 300, and controls the number of the driving pulses output to each of the driving elements 210, 220, 230 and 240 for a unit time according to a dimming signal corresponding to each of the point light source strings 110, 120, 130 and 140. The controller 450 stores a lookup table LUT 451 with respect to the duty ratio corresponding to the detected current. The lookup table LUT 451 may be revised by a user, automatically updated or stored in an additional storage unit other than the controller 450. The control signals with respect to the adjusted duty ratios may be applied to the driving pulses output to the driving elements 210, 220, 230 and 240 through the AND operators 441, 442, 443 and 444, or to the driving pulses output to each of the AND operators 441, 442, 443 and 444 from the driving pulse generator 420. The duty ratios of the driving pulses may be adjusted by various known methods.

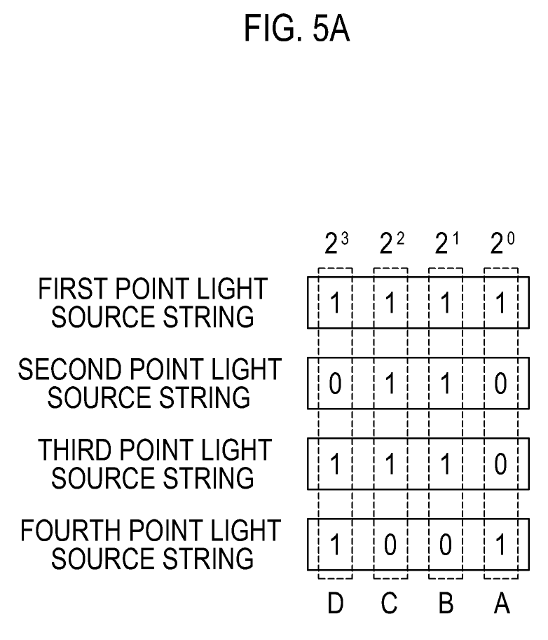

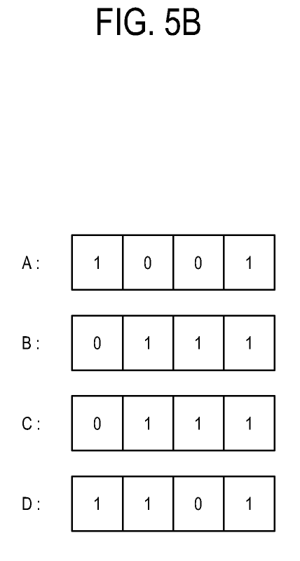

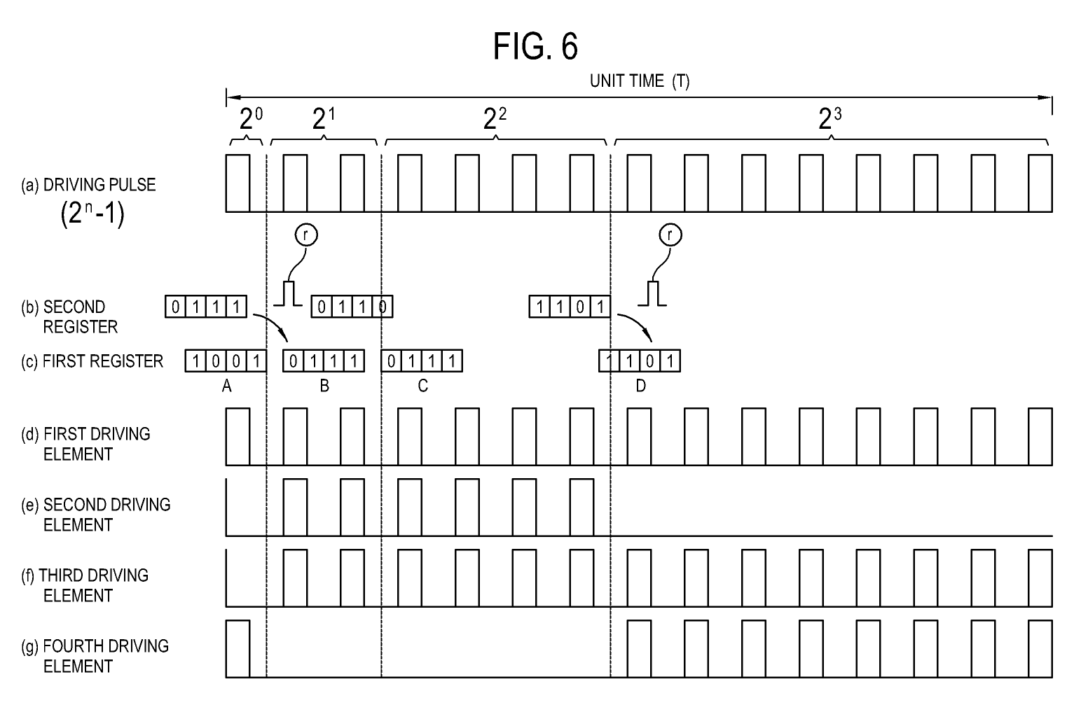

FIG. 5A illustrates dimming signals with respect to a plurality of point light source strings. FIG. 5B illustrates an extraction of dimming signals to output driving pulses to the driving elements 210, 220, 230 and 240. FIG. 6 illustrates signal waveforms with respect to the driving pulses applied to the driving elements. A driving method of the driving elements 210, 220, 230 and 240 by the controller 450 will be described with reference to FIGS. 5A to 6.

Dimming signals are received from the outside to adjust the brightness of the point light source strings 110, 120, 130 and 140 for a unit time T. i.e., for a single driving period. A dimming signal may include a predetermined binary code in the form of an n-bit code. According to the present exemplary embodiment, a dimming signal has in the form of four-bit is input as in FIG. 5A. A dimming signal with respect to a first point light source string 110 is “1111”, a dimming signal with respect to a second point light source string 120 is “0110”, a dimming signal with respect to a third point light source string 130 is “1110” and a dimming signal with respect to a fourth point light source string 140 is “1001”. If the dimming signal has in the form of an n-bit code, brightness of the point light source strings 110, 120, 130 and 140 will range from 0 to 2ⁿ−1, up to a 2ⁿ level. The dimming signal of the first point light source string 110 represents a brightness of 15 corresponding to a decimal value of the binary code, the second light source string 120 represents 6, the third point light source string 130 represents 14 and the fourth light source string 140 represents 9. That is, the plurality of point light source strings 110, 120, 130 and 140 emit light having different brightness for the unit time T, and the light source driver 400 outputs the different driving pulses to the driving elements 210, 220, 230 and 240 to support the foregoing operation.

The driving pulse generator 420 according to the present exemplary embodiment generates 2ⁿ−1 number of driving pulses for the unit time T if the dimming signals are n-bit codes. As the dimming signal is four-bit code, the driving pulse generator 420 generates 15 driving pulses in total for the unit time T and the controller 450 outputs driving pulses with the number of driving pulses corresponding to a decimal value corresponding to the binary code of the dimming signal for the unit time T, to the driving elements 210, 220, 230 and 240. That is, a total of 15 driving pulses are output to the first driving element 210, six driving pulses to the second driving element 220, 14 driving pulses to the third driving element 230 and nine driving pulses to the fourth driving element 240 for the unit time T. The current amount I which is input from the power source unit 410 is adjusted by the driving pulse, and accordingly the brightness of the point light source strings 110, 120, 130 and 140 is controlled.

The controller 450 uses the first and second registers 431 and 433 to output the driving pulses corresponding to each bit of the n-bit code, to the driving elements 210, 220, 230 and 240. The controller 450 extracts a certain binary code from the binary codes of the dimming signals of the plural point source strings 110, 120, 130 and 140 with regard to m-th bits of the n-bit codes of the dimming signals, where “m” is a natural number equal to or greater than one (1). Next, the controller 450 stores the extracted certain binary code in the first register 431 or the second register 433, and outputs the number of driving pulses corresponding to 2^{m-1} and binary code values at the m-th bits of the n-bit codes to the plurality of driving elements 210, 220, 230 and 240 connected to the plurality of point light source strings. As in FIG. 5B, the controller 450 extracts a binary code A, with regard to the first bit of the four-bit code, and extracts next binary codes B, C and D sequentially with regard to next bits. Each of the extracted binary codes forms another binary code having the number of bits corresponding to the number of the point light source strings 110, 120, 130 and 140, and the controller 450 sequentially stores the binary code formed as in FIG. 5B in the first register 431 or the second register 433. If the binary code A is stored first in the first register 431, a single driving pulse corresponding to 20 is output to the first driving element 210 and the fourth driving element 240 having the binary code of 1, respectively. The controller 450 stores the binary code B extracted from the second bit corresponding to 2¹ (FIG. 5A) in the second register 433 while the driving pulse is output according to the binary code A. After the driving pulse is output according to the binary code A, the binary code B which is stored in the second register 433 is stored in the first register 431, and sequentially, two driving pulses corresponding to 2¹ are output to the first to third driving elements 210, 220 and 230 according to the binary code B. The controller 450 may store the binary code A in the first register 431 after storing it not in the first register 431, but in the second register 433. The foregoing extraction of a certain binary code from the n-bit binary codes of the dimming signals may begin from the most significant bits (MSBs) of the n-bit codes or the least significant bits (LSBs).

Next, 2² number of driving pulses are output by the controller 450. The driving pulses which have went through the AND operators 441, 442, 443 and 444 are applied to the first to third driving elements 210, 220 and 230 finally according to the binary code C. The aforementioned description is easily understood also for the binary code D, and the description for the binary code D will be avoided.

According to the present exemplary embodiment, the controller 450 stores the binary code in FIG. 5B in series in the second register 433 to simplify a hardware configuration, and stores the binary code stored in the second register 433, in parallel in the first register 431, to transmit data rapidly. As the data transmission method may be adjusted corresponding to a speed rate of data and a configuration of hardware, the method of storing the binary code is not limited to the foregoing method.

FIG. 6 illustrates driving pulses which are output to each of the driving elements 210, 220, 230 and 240 according to the binary code in FIG. 5B. Element (a) shows driving pulses which are generated for the unit time T. As a dimming signal is in the form of four-bit code, a total of 15 driving pulses are generated for the unit time T.

Elements (b) and (c) illustrate binary codes which are stored in the second register 433 and the first register 431. A binary code A which corresponds to a first bit is stored in the second register 431, and a binary code B is stored in the second register 433 while a single driving pulse is output to the first driving element 210 and the fourth driving element 240 according to the stored binary code A. If an output of the driving pulse with respect to the first bit ends, the controller 450 outputs a latch signal \textcircled{r}, and the binary code B which is stored in the second register 433 is stored in the first register 431 corresponding to the latch signal \textcircled{r}. Two driving pulses are output to the first to third driving elements 210, 220 and 230 by the binary code B.

Then, a binary code C is sequentially stored in the second register 433. Here, the binary code B and the binary code C are the same. In this case, the controller 450 may not output the latch signal \textcircled{r} to store the binary code C stored in the second register 433, in the first register 431. That is, the controller 450 outputs four driving pulses corresponding to the third bit by using the binary code corresponding to the second bit. As described above, the controller 450 may output the latch signal \textcircled{r} only when the binary codes differ, or may output the latch signal \textcircled{r} whenever the binary code is stored with respect to each bit. Otherwise, if the dimming signal is changed during the unit time T, the controller 450 may output the latch signal \textcircled{r} to output the driving pulse according to the changed dimming signal.

Elements (d) to (g) illustrate driving pulses which are output to each of the driving elements 210, 220, 230 and 240 for the unit time T according to the binary code stored in the first register 431. The controller 450 performs a time division operation to the driving power which may be supplied to the point light source strings 110, 120, 130 and 140 for the unit time T, according to the binary code of the dimming signals.

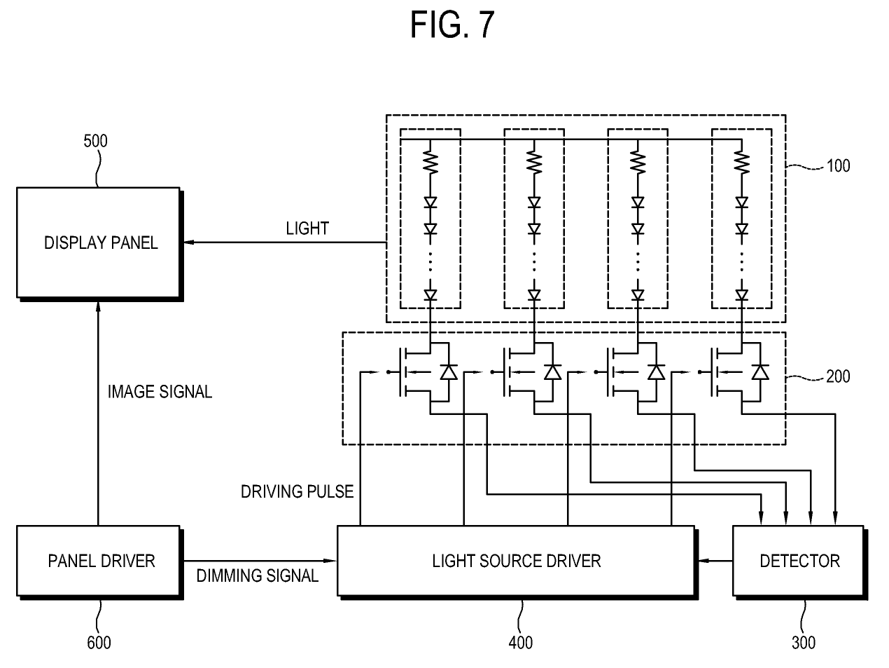

FIG. 7 is a control block diagram of a display apparatus according to another exemplary embodiment of the present invention.

As shown therein, the display apparatus includes a display panel 500, a panel driver 600 to drive the display panel 500, a light source unit 100, a driving element 200 connected to the light source unit 100, a detector 300 to detect a current and a light source driver 400 to drive the driving element 200. The light source unit 100, the driving element 200, the detector 300 and the light source driver 400 are substantially equivalent or similar to those according to the foregoing exemplary embodiment. Thus, repetitive description will be avoided.

The display panel 500 according to the present exemplary embodiment includes a liquid crystal display (LCD) panel which display an image by receiving light from the light source unit 100. The LCD panel includes a liquid crystal layer (not shown) in which light transmittance differs depending on an applied voltage.

The panel driver 600 processes an image signal input from the outside and supplies the processed image signal to the display panel 500. The panel driver 600 includes a panel driving chip (not shown), etc. The panel driver 600 according to the present exemplary embodiment is test-driven by the light source driver 400, and the display panel 500 displays a test image while a duty ratio of a driving pulse is adjusted. The test image may include a black screen so that a user may not recognize the test drive or may include a certain pattern image or a logo indicating the ongoing test drive. The panel driver 600 may also display a graphic user interface (UI) on the display panel 500 to change a setting of brightness by a user.

The panel driver 600 generates a dimming signal to control brightness of the light source unit 100 based on an image signal, and outputs the dimming signal to the light source driver 400. The dimming signal includes a signal corresponding to a gray scale of the image signal. The dimming signal may be set variously by an average value of a gray scale of the image signal, a maximum gray scale value, a minimum gray scale value, etc. If the light source unit 100 includes a plurality of point light source strings, the dimming signal may have different values for each of the point light source strings. Such point light source strings may be disposed in a matrix pattern in a rear side of the display panel 500.

According to another exemplary embodiment, the dimming signal may be generated by the light source driver 400, not by the panel driver 600. In this case, the light source driver 400 may generate a dimming signal in consideration of characteristics of the light source unit 100 by receiving an image signal, or generate a dimming signal under control of the panel driver 600.

As described above, an exemplary embodiment of the present invention may provide a backlight assembly which solves a problem of heat generation by reducing a conduction loss and uniformly controls brightness of emitted light, a driving method thereof and a display apparatus.

Also, an exemplary embodiment of the present invention may provide a backlight assembly which realizes accurate brightness and emits light with an improved contrast ratio, a driving method thereof and a display apparatus.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A backlight assembly, comprising:
a light source unit comprising a plurality of point light source strings;
a plurality of driving elements which are connected to the plurality of point light source strings;
a detector which detects currents flowing in the plurality of point light source strings; and
a light source driver which generates driving pulses to drive the plurality of driving elements in a linear operating region, and adjusts duty ratios of the driving pulses based on at least one of the detected currents so that the currents flowing in the plurality of point light source strings are within a range.

2. The backlight assembly according to claim 1, wherein the light source driver adjusts the duty ratios of the driving pulses so that the plurality of point light source strings provide light of uniform brightness.

3. The backlight assembly according to claim 1, wherein the range is determined according to a preset current range or a current range that is detected from a predetermined reference point light source string of the plurality of point light source strings.

4. The backlight assembly according to claim 1, wherein the light source driver includes a lookup table that stores the duty ratios corresponding to the detected currents.

5. The backlight assembly according to claim 1, wherein the light source driver sequentially test-drives the plurality of driving elements and adjusts the duty ratios of the driving pulses when a system-on signal is received or when settings of brightness of light emitted from the plurality of point light source strings are changed.

6. The backlight assembly according to claim 1, wherein the plurality of driving elements comprise switch elements, and the switch elements act as switches in the linear operating region.

7. The backlight assembly according to claim 1, wherein the light source driver comprises a power source unit which is connected to the light source unit and supplies predetermined constant power to the light source unit;
a driving pulse generator which generates the driving pulses; and
a controller which adjusts numbers of the driving pulses output to the plurality of driving elements in a unit time according to corresponding dimming signals for the plurality of point light source strings.

8. The backlight assembly according to claim 7, wherein the driving pulse generator generates 2ⁿ−1 number of driving pulses in the unit time if the dimming signals, each having a predetermined binary code, are input in the form of an n-bit code, the “n” being a natural number equal or greater than one (1), and
wherein the controller outputs the number of the driving pulses to the plurality of driving elements such that each of the plurality of driving elements receives a number of driving pulses corresponding to a decimal value of the binary code of a dimming signal for a corresponding point light source string of the plurality of point light source strings in the unit time.

9. The backlight assembly according to claim 8, wherein the light source driver further comprises a storage unit which includes a first register and a second register each comprising a number of bits corresponding to a number of the plurality of point light source strings, and
wherein the controller extracts a first predetermined code from the predetermined binary codes of the dimming signals for the point light source strings with regard to m-th bits of n-bit codes of the dimming signals, the “m” being a natural number equal or greater than one (1), stores the first predetermined code in the first register, and outputs the number of the driving pulses corresponding to 2^{m-1} and binary values of the m-th bits of the n-bit codes to the plurality of driving elements.

10. The backlight assembly according to claim 9, wherein the controller stores a second predetermined code with regard to a bit next to the m-th bit in the second register during which the driving pulses are output according to the first predetermined code stored in the first register.

11. The backlight assembly according to claim 10, wherein the controller outputs a latch signal to store in the first register the second predetermined code previously stored in the second register if the second predetermined code stored in the second register is different from the first predetermined code stored in the first register.

12. The backlight assembly according to claim 10, wherein the light source driver further comprises a plurality of AND operators,
wherein each of the plurality of AND operators receives a respective binary value of the first predetermined code stored in the first register, and the driving pulses output from the driving pulse generator for a respective AND operation, and
wherein output terminals of the plurality of AND operators are connected to the plurality of driving elements.

13. The backlight assembly according to claim 10, wherein the controller stores the second predetermined code in series in the second register, and stores in the first register in parallel the first predetermined code previously stored in the second register.

14. A driving method of a backlight assembly which includes a light source unit comprising a plurality of point light source strings, and a plurality of driving elements connected to the plurality of point light source strings, the driving method comprising:
driving the plurality of driving elements;
detecting currents flowing in the plurality of point light source strings;
generating driving pulses to drive the plurality of driving elements in a linear operating region;
adjusting duty ratios of the driving pulses based on the detected currents so that the currents flowing in the plurality of point light source strings are within a range; and
outputting to the plurality of driving elements the driving pulses of which duty ratios are adjusted, according to dimming signals to control brightness of the plurality of point light source strings.

15. The driving method according to claim 14, wherein the duty ratios of the driving pulses are adjusted so that the plurality of point light source strings provide light of uniform brightness.

16. The driving method according to claim 14, wherein the range is determined according to a preset current range or a current range detected from a predetermined reference point light source string of the plurality of point light source strings.

17. The driving method according to claim 14, wherein the driving the plurality of driving elements comprises sequentially test-driving the plurality of driving elements when a system-on signal is received or when settings of brightness of light emitted from the plurality of point light source strings are changed.

18. The driving method according to claim 14, wherein the outputting to the plurality of driving elements the driving pulses comprises:
generating 2ⁿ−1 number of driving pulses in a unit time if the dimming signals, each having a predetermined binary code, are input in the form of an n-bit code
extracting a first predetermined code from the binary codes of the dimming signals for the plural point light source strings with regard to m-th bits of n-bit codes of the dimming signals; and
outputting the number of the driving pulses corresponding to 2^{m-1} and binary values of the m-th bits of the n-bit codes to the driving elements,
wherein the “m” and “n” are natural numbers equal to or greater than one (1).

19. The driving method according to claim 18, further comprising extracting and outputting a second predetermined code from the binary codes of the dimming signals with regard to an adjacent bit during which the driving pulses are output according to the first predetermined code.

20. A display apparatus, comprising:
a display panel which displays an image thereon;
a panel driver which applies an image signal to the display panel;
a light source unit which comprises a plurality of point light source strings;
a plurality of driving elements which are connected to the plurality of point light source strings;
a detector which detects currents flowing in the plurality of point light source strings; and
a light source driver which generates driving pulses to drive the plurality of driving elements in a linear operating region, drives the plurality of driving elements to detect currents flowing in the plurality of point light source strings, adjusts duty ratios of the driving pulses based on the detected currents so that the currents flowing in the plurality of point light source strings are within a range, and outputs to the plurality of driving elements the driving pulses of which duty ratios are adjusted, according to dimming signals based on the image signal.

21. The display apparatus according to claim 20, wherein the light source driver sequentially test-drives the plurality of driving elements and adjusts duty ratios of the driving pulses when a system-on signal is received or when settings of brightness of light emitted from the plurality of point light source strings are changed.
